(19) United States
(12) Patent Application Publication
(10) Pub. No.: US 2009/0310716 A1
(43) Pub. Date: Dec. 17, 2009

(54) CHANNEL BIT DETECTION SYSTEM

(75) Inventors: Meng-Ta YANG, Miaoli County (TW); Hong-Ching CHEN, Kao-Hsiung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/137,108

(22) Filed: Jun. 11, 2008

(51) Int. Cl. H04L 27/06

(52) U.S. Cl. 375/340

(57) ABSTRACT

A channel bit detection system is provided. The channel bit detection system includes an RF front end, an analog-to-digital converter, a combiner, a length estimator, a length accumulator, an offset control, and a channel bit detector. The RF front end receives an RF signal, and is then digitized at a sampling rate R into a plurality of samples by the analog-to-digital converter. The combiner produces combined samples by shifting the plurality of samples an offset value. The length estimator estimates a length of each two consecutive combined samples. The length accumulator produces land lengths and pit lengths of the combined samples according to length of each two consecutive combined samples. The offset control provides the offset value according to the land lengths and the pits lengths. The channel bit detector recovers the channel bit from the plurality of combined samples.

### BACKGROUND OF THE INVENTION

1. Field of the Invention

The invention relates to optical storage systems, and, more particularly, to techniques of signal reproduction in an optical system.

2. Description of the Related Art

Channel coding is generally employed in optical recording to match certain properties of the coded sequence to the channel characteristics of the recorder. Because optical recorders are typically inadequate in reproducing very low frequencies or direct current (DC) component, a coding method for controlling the DC component in code streams is required. The DC component is the result of an unequal number of binary digits (“1”s and “−1”s) in the transmitted binary signal. One method for minimizing the DC component is to calculate a digital sum value (DSV) and compensates the coded sequence to control the DSV for approaching zero.

A digital data slicer is employed when decoding the channel bits. The slicer compares an input value with a reference value, and slices the input samples to either 1 or −1, thus, a slicer capable of properly slicing level-slices of the code streams is preferable. When the slicing level significantly fluctuates or shifts from the center of the reproduction signal RF, the DSV value of an input stream correspondingly fluctuates or disperses. As a result, the level-sliced data cannot be stably obtained.

### BRIEF SUMMARY OF THE INVENTION

Accordingly, the invention provides a channel bit detection system capable of precise level slicing. In one aspect of the invention, a channel bit detection system is provided. The channel bit detection system comprises an RF front end, an analog-to-digital converter (ADC), a combiner, a sign detector, an interpolation filter, an accumulator, and an offset control. The RF front end receives an RF signal. The RF signal is then converted into a plurality of samples at a sampling rate R by an analog-to-digital converter (ADC). Each converted sample is then shifted by an offset value by the combiner. The interpolation filter produces a plurality of interpolated samples by interpolating and low-pass filtering the combined samples. The interpolated samples have an interpolated sampling rate W, which exceeds the sample rate R. The sign detector detects signs of the interpolated samples. The accumulator accumulates the signs of each polarity for a predetermined time interval to produce an accumulated value. The offset control updates the offset value according to the accumulated value. A channel bit detector receives the combined samples to decode channel bits from the RF signals. The channel bit detector preferably further comprises a phase locked loop (PLL) coupled to the combiner, recovering a clock signal from the combined samples. The clock signal has a clock rate R, and the analog-to-digital converter converts the RF signal into a plurality of samples according to the clock signal.

In another aspect of the invention, a channel bit detection system with a digital-to-analog converter (DAC) and a DSV calculator is provided. The channel bit detection system comprises an RF front end, a digital-to-analog converter, a combiner, a one-bit analog-to-digital converter, a DSV calculator, and an offset control. The RF front end receives an RF signal. The digital-to-analog converter (DAC) receives an offset value, and converts the offset value into the analog signal. The combiner combines the RF signal and the analog signal to form a combined signal. The one-bit analog-to-digital converter converts the combined signal into a plurality of first samples at a sampling rate W. The one-bit analog-to-digital converter converts the combined samples into a binary bit stream. The DSV calculator receives the plurality of first samples for calculating a digital sum value (DSV) of the first samples. The offset control updates the offset value according to the digital sum value. For example, the offset control adjusts the offset value so that the accumulated value of the interpolated samples approach zero. An analog-to-digital converter (ADC) converts the combined signal into a plurality of samples at a sampling rate R, wherein the sampling rate R is less than the sampling rate W. A channel bit detector recovers the channel bits from the plurality of samples. Preferably, the channel bit detector further comprises a phase locked loop (PLL) coupled to the combiner recovering a clock signal from the combined samples. The clock signal has a clock rate R, and the analog-to-digital converter converts the RF signal into a plurality of samples according to the clock signal.

In another aspect of the invention, a channel bit detector having a length estimator is provided. The channel bit detection system comprises an RF front end, an analog-to-digital converter, a combiner, a length estimator, a length accumulator, an offset control, and a channel bit detector. The RF front end receives an RF signal. The RF signal is digitized at a sampling rate R into a plurality of samples by the analog-to-digital converter. The combiner produces combined samples by shifting the plurality of samples by an offset value or shifting a slice level, thus shifting the values of all the samples. The length estimator estimates a length of each two consecutive combined samples. The length accumulator analyzes the lengths of each two consecutive combined samples. The length accumulator produces land lengths and pit lengths of the combined samples according to the length of each two consecutive combined samples. The offset control provides the offset value according to the land lengths and the pits lengths. The channel bit detector recovers the channel bit from the plurality of combined samples.

In another aspect of the invention, a channel bit detection system separately adjusts the PLL and the channel bit detector. The channel bit detection system has an RF front end receives an RF signal. The RF signal is converted by an analog-to-digital converter (ADC) into a plurality of samples at a sampling rate R. A first combiner produces first combined samples by shifting the plurality of samples by a first offset value. The second combiner combines the plurality of samples with a second offset control. The first offset value is calculated according to land lengths and pits lengths, generated by the length estimator and the length accumulator. The second offset value is formed from a DSV calculator, which calculates a digital sum value of the channel bits. The first combiner and the second combiner respectively provide an output node A and an output node B. A phase-locked loop and a channel bit detector selectively connect to node A or node B. Preferably, the phase-locked loop connects to node A while the channel bit detector connects to node B. In other embodiments, the phase-locked loop connects to node B while the channel bit detector connects to node A.

In another aspect of the invention, a channel bit detection system has 3 different slicing levels. The channel bit detection system comprises an RF front end, an analog-to-digital converter, a combiner, a slice level control, a phase-locked loop and a channel bit detector. The RF front end receives an RF signal. The analog-to-digital converter (ADC) converts the RF signal into a plurality of samples at a sampling rate R. The combiner receives the plurality of samples, a slicing level value (S_L) and a delta value (Δ) to produce a first sliced data, a second sliced data and a third sliced data. Subtracting the slicing level value and subtracting the delta value from each of the plurality of samples produces the first sliced data. Subtracting the slicing level value from each of the plurality of samples produces the second sliced data and adding the delta value with each of the plurality of samples and then subtracting the slicing level value produces the third sliced data. The slicing level control collects the first, second and third sliced data, detects signs of the first, second and third sliced data, accumulates the signs for a predetermined time interval to produce a first, second and third accumulated values. The slicing level value is then updated according to the first, second and third accumulated values. A channel bit detector and a phase-locked loop receives the slicing level to respectively recover channel bits and a clock signal from the combined samples.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 shows channel bit detection system according to the first embodiment of the invention;

FIG. 2a shows an RF signal;

FIG. 2b shows converted samples corresponding to the RF signal shown in FIG. 2a;

FIG. 2c and 2d show combining the converted samples with an offset value according to the first embodiment of the invention;

FIG. 2e shows an example of interpolating the combined samples;

FIG. 3 is a block diagram of a channel bit detection system according to the second embodiment of the invention;

FIG. 4a-4d respectively show an RF signal, converted samples, and combined samples according to the second embodiment of the invention;

FIG. 5 is a block diagram of a channel bit detection system according to the third embodiment of the invention;

FIG. 6a-6b respectively show an RF signal and converted samples in accordance with the third embodiment;

FIG. 7 is a block diagram of a channel bit detection system according to the fourth embodiment of the invention;

FIG. 8 is a block diagram of a modified channel bit detection system according to the fourth embodiment of the invention;

FIG. 9 is a block diagram of a channel bit detection system according to the fifth embodiment of the invention;

FIG. 10 shows a block diagram of a slicing level control according to the fifth embodiment of the invention;

FIG. 11 is a block diagram of a slicing level control according to the fifth embodiment of the invention; and

FIG. 12a, 12b, and 12c are three diagrams respectively showing slicing of the samples by the slicing level, the slicing level+Δ and the slicing level−Δ in accordance with the fifth embodiment of the invention.

### DETAILED DESCRIPTION OF THE INVENTION

### First Embodiment

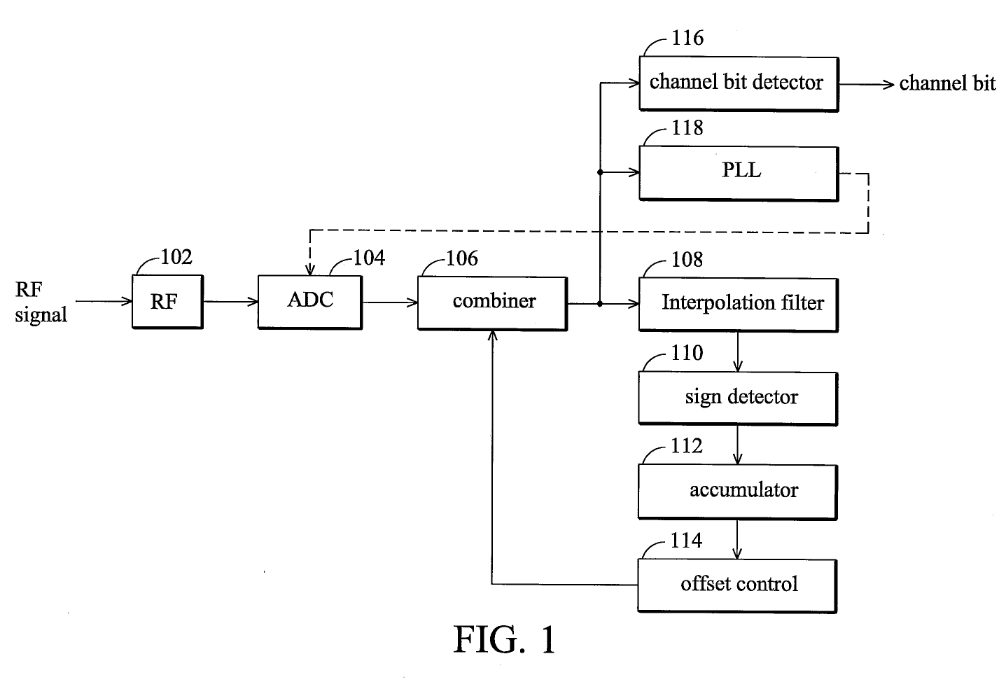

FIG. 1 shows channel bit detection system according to a first embodiment of the invention. The channel bit detection system comprises an RF front end 102, an analog-to-digital converter (ADC) 104, a combiner 106, a sign detector 110, an interpolation filter 108, an accumulator 112, an offset control 114, a channel bit detector 116 and a PLL circuit 118. The RF front end 102 receives an RF signal, and the analog-to-digital converter (ADC) 104 converts the RF signal into a plurality of samples at a sampling rate R. The combiner 106 produces combined samples by shifting the plurality of samples by an offset value or a slice level, and the interpolation filter 108 produces a plurality of interpolated samples by interpolating and low-pass filtering the combined samples. The sign detector 110 detects signs of the plurality of interpolated samples, and the accumulator 112 accumulates the signs of the interpolated samples to produce an accumulated value. The offset control 114 then adjusts the offset value or the slice level used in the combiner 106 according to the accumulated value. In addition, the channel bit detector 116 is used to decode channel bits and the PLL circuit 118 is used to recover a clock signal, which is utilized in the analog-to-digital converter 104, from the combined samples.

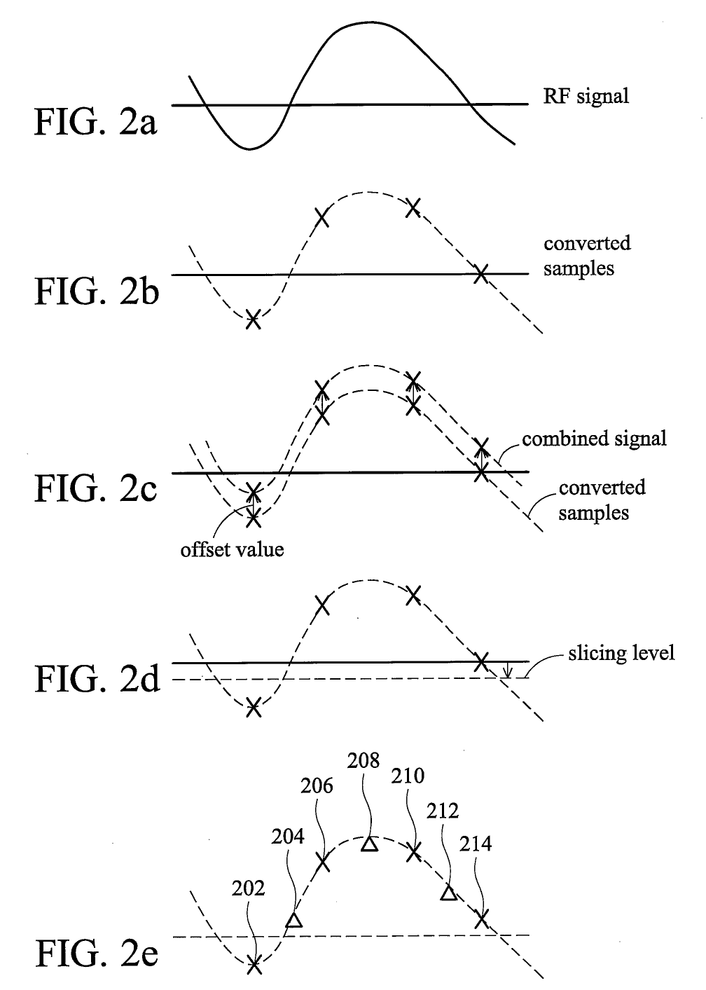

The operation of the channel bit detection system in accordance with the first embodiment is explained in accompany with FIG. 2a˜FIG. 2e, which illustrate various signal waveforms in the FIG. 1. FIG. 2a shows an RF signal, and FIG. 2b shows converted samples corresponding to the RF signal. Each converted samples is then shifted an offset value by the combiner 106. FIG. 2c shows an exemplary of combining the converted samples with an offset value. In some embodiments, the combiner 106 shifts a slicing level to obtain substantially the same results, as shown in FIG. 2d. The interpolation filter 108 produces a plurality of interpolated samples by interpolating and low-pass filtering the combined samples. FIG. 2e shows an example of interpolating the combined samples.

The interpolated samples have an interpolated sampling rate W, which exceeds the sample rate R. The sign detector 110 detects signs of the plurality of interpolated samples. For example, the interpolated samples 202-214 have signs −, +, +, +, +, +, and +, respectively. The accumulator 112 accumulates the signs of each polarity for a predetermined time interval to produce an accumulated value. In the embodiment, the accumulated value is 5, by summing −1, 1, 1, 1, 1, 1, and 1. The offset control 114 updates the offset value according to the accumulated value. For example, the offset control 114 adjusts the offset value so that the accumulated value of the interpolated samples approach zero. A channel bit detector 116 receives the combined samples to decode channel bits from the RF signals. Preferably, the channel bit detection system further comprises a phase locked loop (PLL) 118 coupled to the combiner, recovering a clock signal from the combined samples. The clock signal has a clock rate R, and the analog-to-digital converter 104 converts the RF signal into a plurality of samples according to the clock signal. In some embodiments, the accumulator 112 comprises a counter. The counter increments by one when receiving a positive interpolated sample, and decrements by one when receiving a negative interpolated sample.

### Second Embodiment

In the first embodiment, the offset value or the slice level, applied to level shifting performed by the combiner, is adjusted by the offset control based on the signs of the samples corresponding to the RF signal. In the present embodiment, the offset value of the slice level is adjusted based on land/pit lengths of the RF signal.

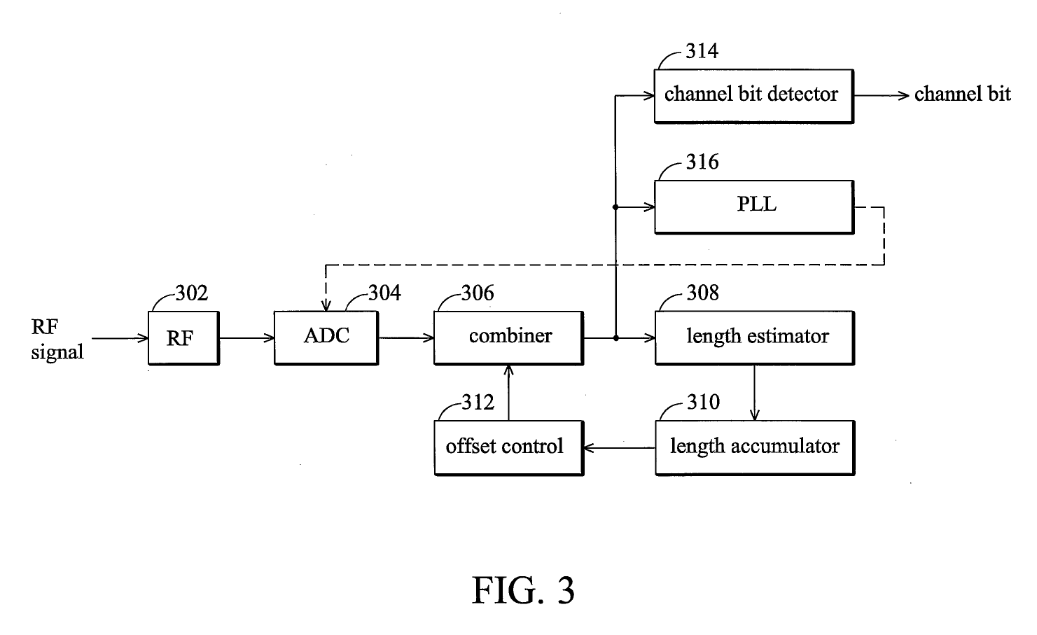

FIG. 3 is a block diagram of a channel bit detection system according to the second embodiment of the invention. The channel bit detector comprises an RF front end 302, an analog-to-digital converter 304, a combiner 306, a length estimator 308, a length accumulator 310, an offset control 312, a channel bit detector 314 and a PLL circuit 316. The RF front end 302 receives an RF signal. The RF signal is digitized at a sampling rate R to a plurality of samples by the analog-to-digital converter 304. The combiner 306 produces combined samples by shifting the plurality of samples by an offset value or shifting a slice level, thus, the values of all samples are shifted. The length estimator 310 estimates a length of each two consecutive combined samples. Then the length accumulator 310 analyzes the length of each two consecutive combined samples to produces land lengths and pit lengths of the combined samples. Finally, The offset control 312 adjusts the offset value or the slice level used in the combiner 306 according to the pit lengths and the land lengths.

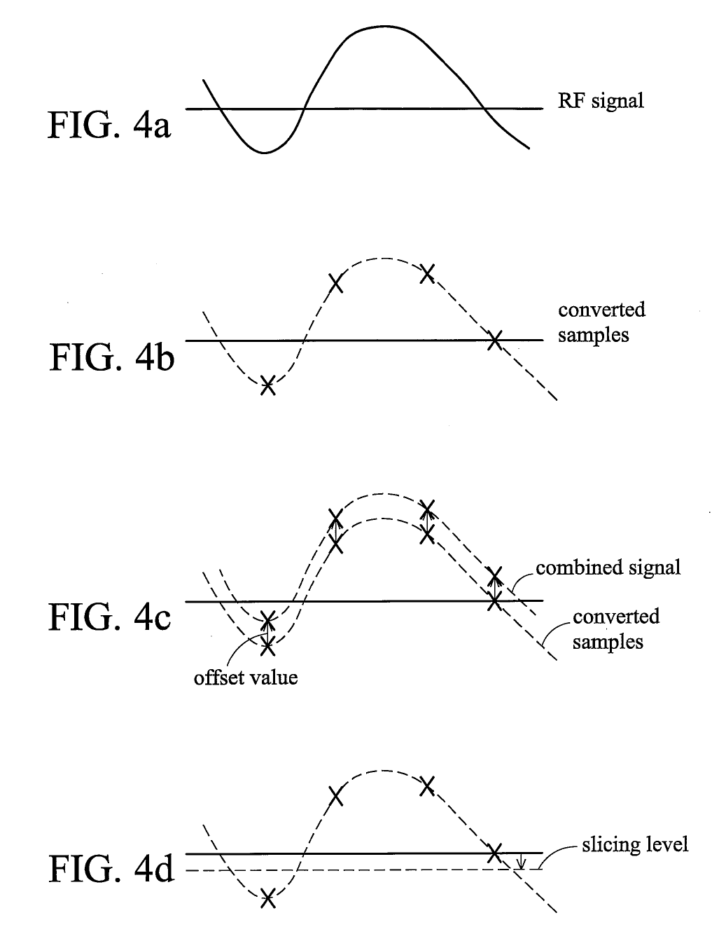

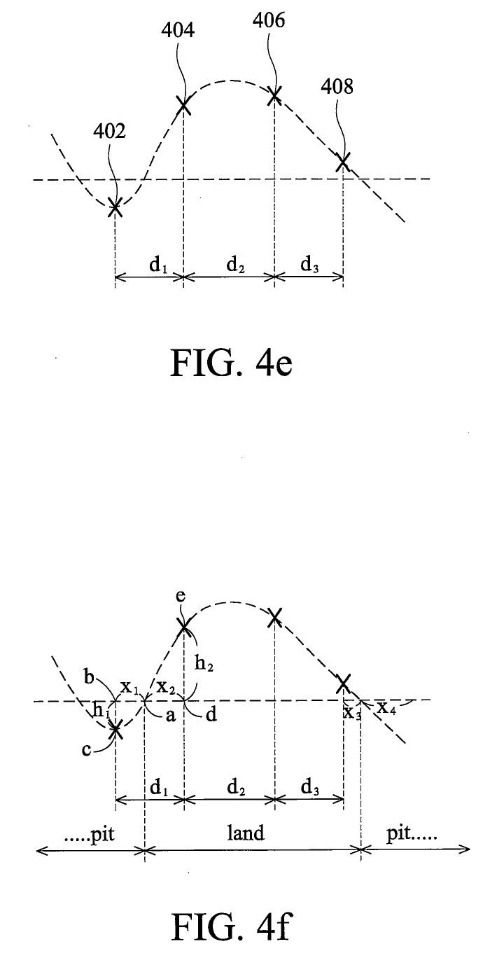

The operation of the channel bit detection system in accordance with the second embodiment is explained in accompany with FIG. 4a˜FIG. 4f, which illustrate various signal waveforms in the FIG. 3. FIGS. 4a-4d respectively show an RF signal, converted samples, and combined samples, where FIG. 4c illustrates a combined signal generated using an offset value and FIG. 4d illustrates a combined signal generated using a slice level. As described above, the length estimator 310 estimates a length of each two consecutive combined samples. FIG. 4e shows the lengths of samples 402-404 (d₁), 402-404 (d₂), and 404-406 (d₃). The length accumulator 310 analyzes the length of each two consecutive combined samples d1, d2, and d3. The length accumulator 310 produces land lengths and pit lengths of the combined samples according to length of each two consecutive combined samples.

FIG. 4f shows an exemplary analysis of d₁, d₂, and d₃. First, a zero-crossing point is detected between samples 402-404 of FIG. 4e. Second, assume triangle Δ abc is similar to triangle Δ ade. Given the sample value h₁ and h₂, and duration d₁, the width of line ab and line da can be calculated.

For example, set line ab=x₁, line da=x₂=d₁−x₁,

$$since \frac{{h}_{1}}{{x}_{1}} = \frac{{h}_{2}}{{d}_{1} - {x}_{1}} , \\ then {x}_{1} = \frac{{h}_{1} \cdot {d}_{1}}{( {h}_{1} + {h}_{2} )} , and {x}_{2} = \frac{{h}_{2} \cdot {d}_{1}}{( {h}_{1} + {h}_{2} )} .$$

Similarly, x₃ and x₄ can be also calculated. Third, sum x₂, d₂, d₃, and x₃ can be calculated to obtain a land length. The pit length can be similarly calculated, thus, further description is omitted for brevity. The offset control 312 in FIG. 3 provides the offset value according to the land lengths and the pits lengths. The channel bit detector 314 recovers the channel bit from the plurality of combined samples.

### Third Embodiment

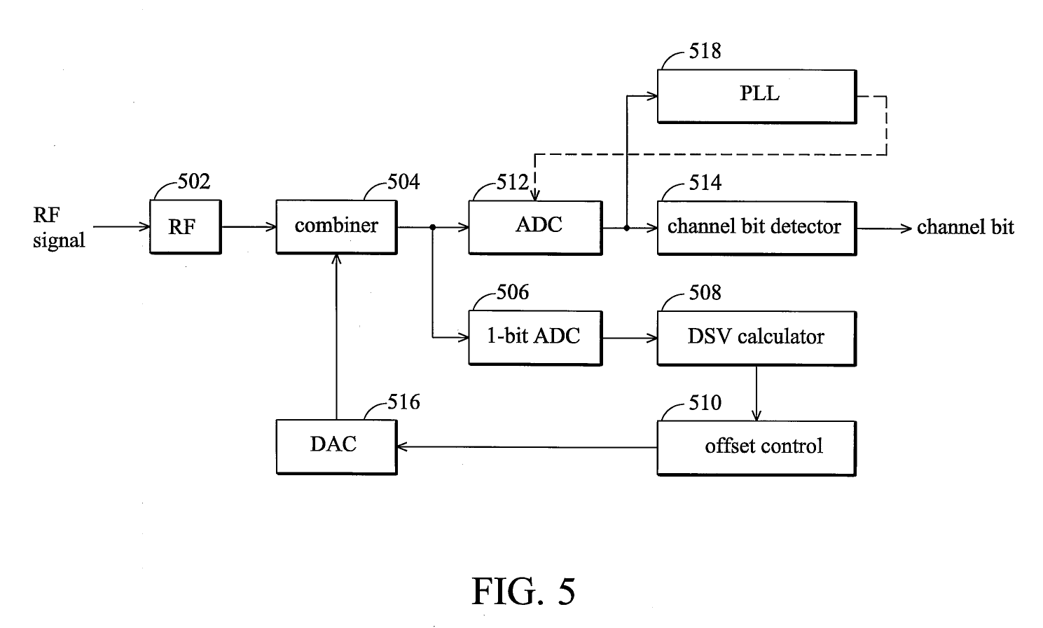

The present embodiment, different to the first and second embodiments, utilizes the digital sum value (DSV) technique to adjust the offset value applied in level shifting performed by the combiner. FIG. 5 is a block diagram of a channel bit detection system according to the third embodiment, which comprises an RF front end 502, a combiner 504, a one-bit analog-to-digital converter 506, a DSV calculator 508, an offset control 510, a digital-to-analog converter 516, an analog-to-digital converter 512, a channel bit detector and a PLL circuit 518. The RF front end 502 receives an RF signal. The one-bit analog-to-digital converter 506 converts the combined signal into a plurality of first digital samples at a sampling rate. The first digital samples look like a binary bit stream. The DSV calculator 508 receives the first digital samples to calculate a digital sum value (DSV) of the first digital samples. Then the offset control 510 updates the offset value according to the digital sum value obtained by the DSV calculator 508. The digital-to-analog converter (DAC) 516 receives the offset value, and converts the offset value from digital form to analog form. The combiner 504 combines the RF signal and the offset value to form a combined signal.

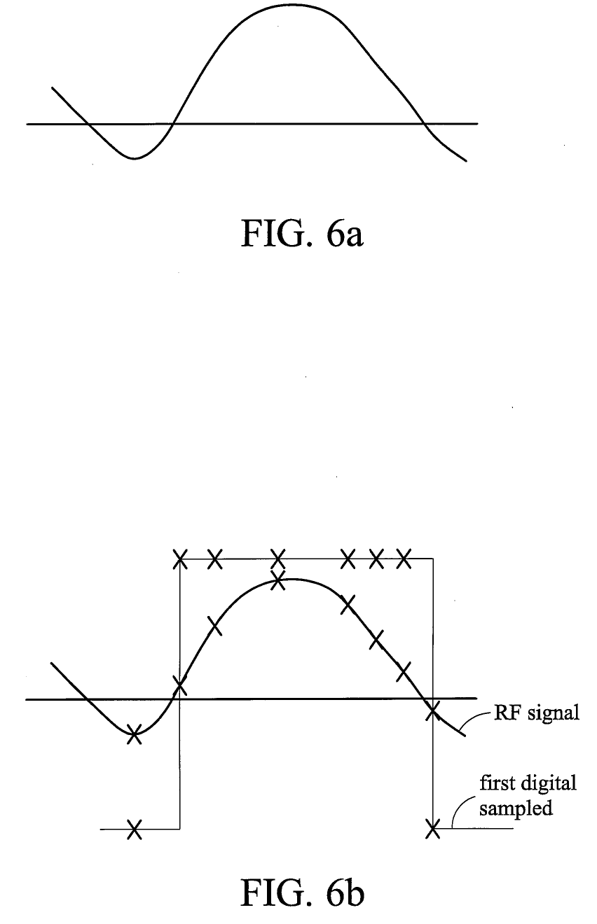

The operation of the channel bit detection system in accordance with the third embodiment is explained in accompany with FIG. 6a and FIG. 6b. FIGS. 6a-6b respectively show an RF signal and converted samples. As described above, the one-bit analog-to-digital converter 506 converts the combined signal into a plurality of first digital samples at a sampling rate W. In other words, the one-bit analog-to-digital converter 506 converts the combined samples into a binary bit stream {0, 1, 1, 1, 1, 1, 1, 0}, as shown in FIG. 6b. The DSV calculator 508 receives the plurality of first digital samples to calculate a digital sum value (DSV) of the first digital samples. In this embodiment, the DSV is represented as the following sequence: {0, 1, 2, 3, 4, 5, 6, 5}. The offset control 510 updates the offset value according to the obtained digital sum value. For example, the offset control 510 adjusts the offset value, thus, the accumulated value of the interpolated samples approach zero. Analog-to-digital converter (ADC) 512 converts the combined signal into a plurality of samples at a sampling rate R, wherein the sampling rate R is less than the sampling rate W. A channel bit detector 514 recovers the channel bits from the plurality of samples. Preferably, the channel bit detection system further comprises a phase locked loop (PLL) 518 coupled to the combiner, recovering a clock signal from the combined samples. The clock signal has a clock rate R, and the analog-to-digital converter 512 converts the RF signal into a plurality of samples according to the clock signal.

### Fourth Embodiment

The combined samples are sometimes optimal for a phase-locked loop, but the combined samples cause extra channel bit errors because the slice level controlled by length estimation is only sometimes optimal for a phase-locked loop, not for a channel bit detector. In the present embodiment, two combiners respectively provide two combined samples to the phase-locked loop and channel bit detector.

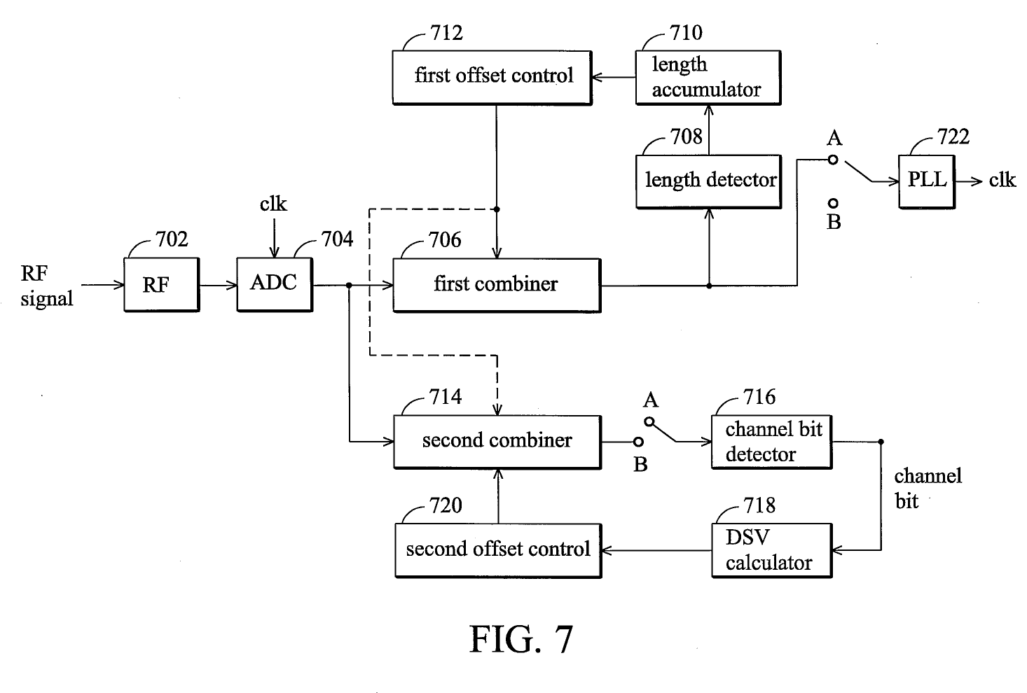

FIG. 7 is a block diagram of a channel bit detection system according to the fourth embodiment of the invention, which comprises an RF front end 702, an analog-to-digital converter 704, a first combiner 706, a length detector 708, a length accumulator 710, a first offset control, a second offset control, a channel bit detector 716, a DSV calculator 718, a second offset control 720 and a PLL circuit 722.

An RF front end 702 receives an RF signal. The RF signal is converted by an analog-to-digital converter (ADC) 704 into a plurality of samples at a sampling rate R. A first combiner 706 produces first combined samples by shifting the plurality of samples by a first offset value. The second combiner 714 combines the plurality of samples with a second offset control. The first offset value is calculated according to land lengths and pits lengths, respectively generated by length estimator 708 and length accumulator 710. The land and pit lengths can be calculated by an approach similar to the second embodiment, further description is thus omitted for brevity. The second offset value is formed from a DSV calculator 718, which calculates a digital sum value of the channel bits. The first combiner 706 and the second combiner 714 respectively provide an output node A and an output node B. A phase-locked loop 722 and a channel bit detector 716 selectively connect to node A or node B. Preferably, the phase-locked loop 722 connects to node A while the channel bit detector 716 connects to node B. In some embodiments, the phase-locked loop 722 connects to node B while the channel bit detector connects to node A.

In other embodiments, the second combiner 714 further combines the first offset value to produce the second combined samples.

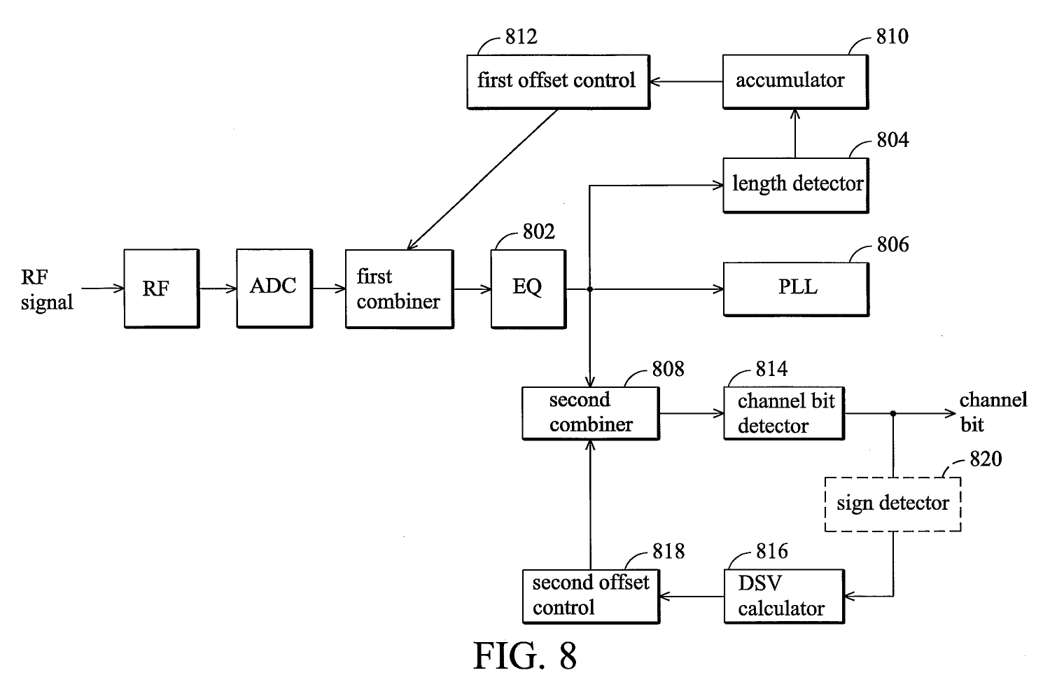

FIG. 8 is a block diagram of a modified channel bit detection system according to the embodiment of the invention. In this modified embodiment, an equalizer 802 is inserted for equalizing first combined samples to produce equalized samples. The length estimator 804 and phase-locked loop 806 takes the equalized samples rather than the plurality of samples. The second combiner 808 produces a second combined data by combining the equalized samples with a second offset control. The function of length accumulator 810, first offset control 812, channel bit detector 814, DSV calculator 816, and second offset control 818 are substantially the same as previously described, thus further description is omitted. In some embodiments, a sign detector 820 is coupled to the channel bit detector 814, detecting the signs of the channel bit, and the DSV calculator 816 calculates the DSV of the signs.

### Fifth Embodiment

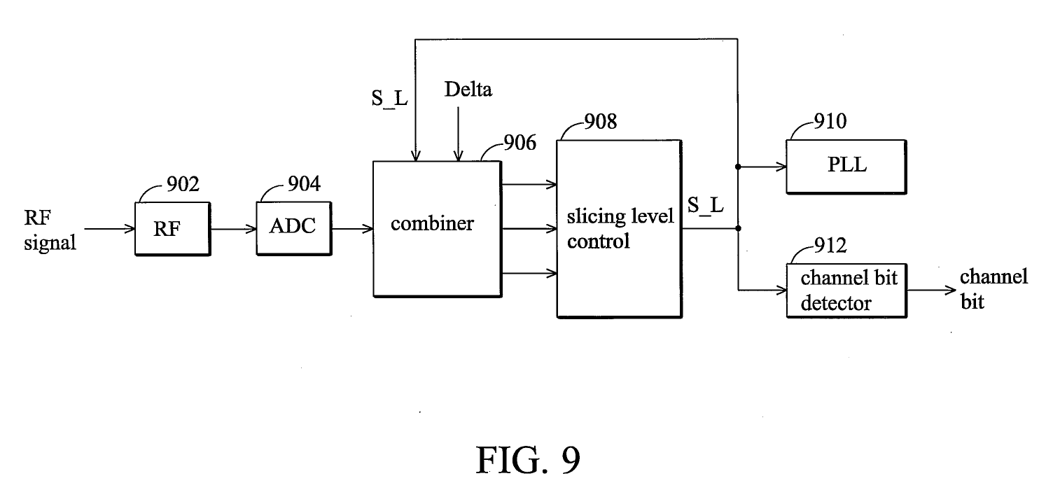

The present embodiment, different to the first and second embodiments, utilizes the digital sum value (DSV) technique to adjust the offset value applied in level shifting performed by the combiner. FIG. 9 is a block diagram of a channel bit detection system according to the fifth embodiment of the invention. The channel bit detection system comprises an RF front end 902, an analog-to-digital converter 904, a combiner 906, a slice level control 908, a phase-locked loop 910 and a channel bit detector 912. The RF front end 902 receives an RF signal. The analog-to-digital converter (ADC) 904 converts the RF signal into a plurality of samples at a sampling rate R. The combiner 906 receives the plurality of samples, a slicing level value (S_L) and a delta value (Δ) to produce a first sliced data, a second sliced data and a third sliced data. Subtracting the slicing level value and subtracting the delta value from each of the plurality of samples produces the first sliced data. Subtracting the slicing level value from each of the plurality of samples produces the second sliced, and adding the delta value to each of the plurality of samples and then subtracting the slicing level value produces the third sliced data. The slicing level control 908 collects the first, second and third sliced data, detects signs of the first, second and third sliced data, accumulates the signs for a predetermined time interval to produce a first, second and third accumulated values. The slicing level value is then updated according to the first, second and third accumulated values. A channel bit detector 912 and a phase-locked loop 910 receives the slicing level to respectively recover channel bits and a clock signal from the combined samples.

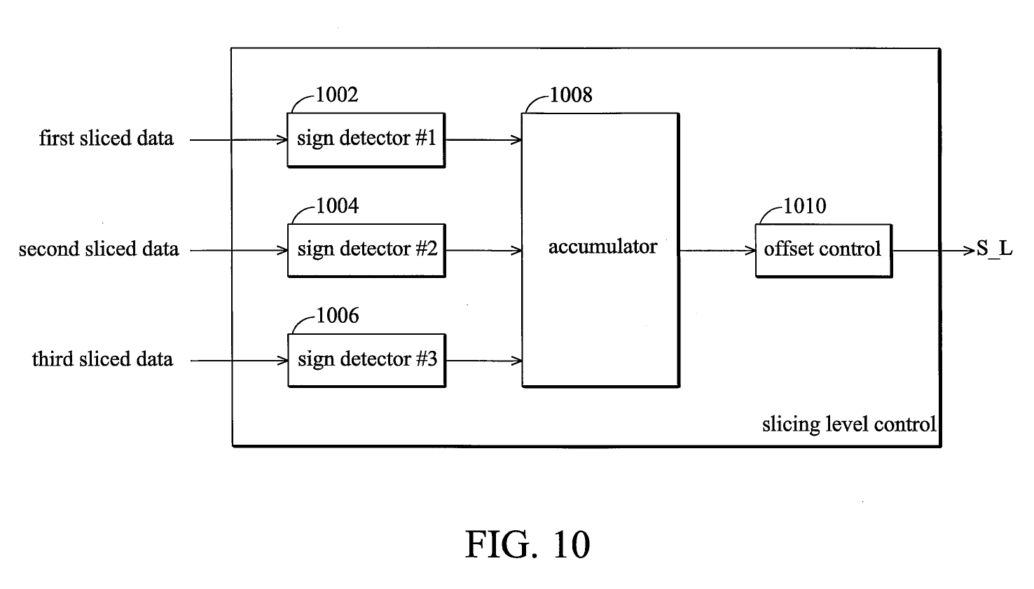

In some embodiments, the slicing level control 908 has 3 sign detectors 1002-1004, an accumulator 1008 and an offset control 1010, as shown in FIG. 10. A first sign detector 1002 detects the signs of the first sliced data. A second sign detector 1004 detects the signs of the second sliced data. A third sign detector 1006 detects the signs of the third sliced data. The accumulator 1008 collects the first, second and third sliced data for summing the three signs and accumulating the signs for a predetermined time interval to produce an accumulated value. The offset control 1010 updates the slicing level value according to the accumulated value.

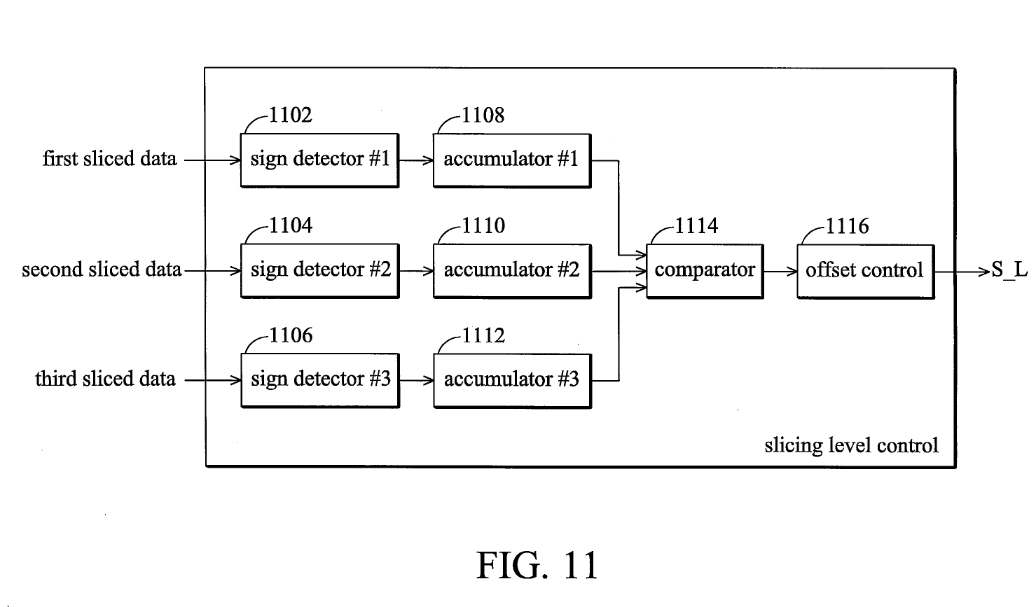

In other embodiments, the slicing level control 908 comprises 3 sign detectors 1102-1106, 3 accumulators 1108-1112, a comparator 1114 and an offset control 1116, as shown in FIG. 11. A first sign detector 1102 detects the signs of the first sliced data, a second sign detector 1104 detects the signs of the second sliced data, and a third sign detector 1106 detects the signs of the third sliced data. A first accumulator 1108 accumulates the signs of the first sliced data for a predetermined time interval to produce a first accumulated value. A second accumulator 1110 accumulates the signs of the second sliced data for the duration of the predetermined time interval to produce a second accumulated value. The third accumulator 1112 accumulates the signs of the third sliced data for the duration of the predetermined time interval to produce a third accumulated value. The comparator 1114 compares the first, second and third accumulated values, and selects a minimum accumulated value. The offset control 1116 updates the slicing level value according to the minimum accumulated value.

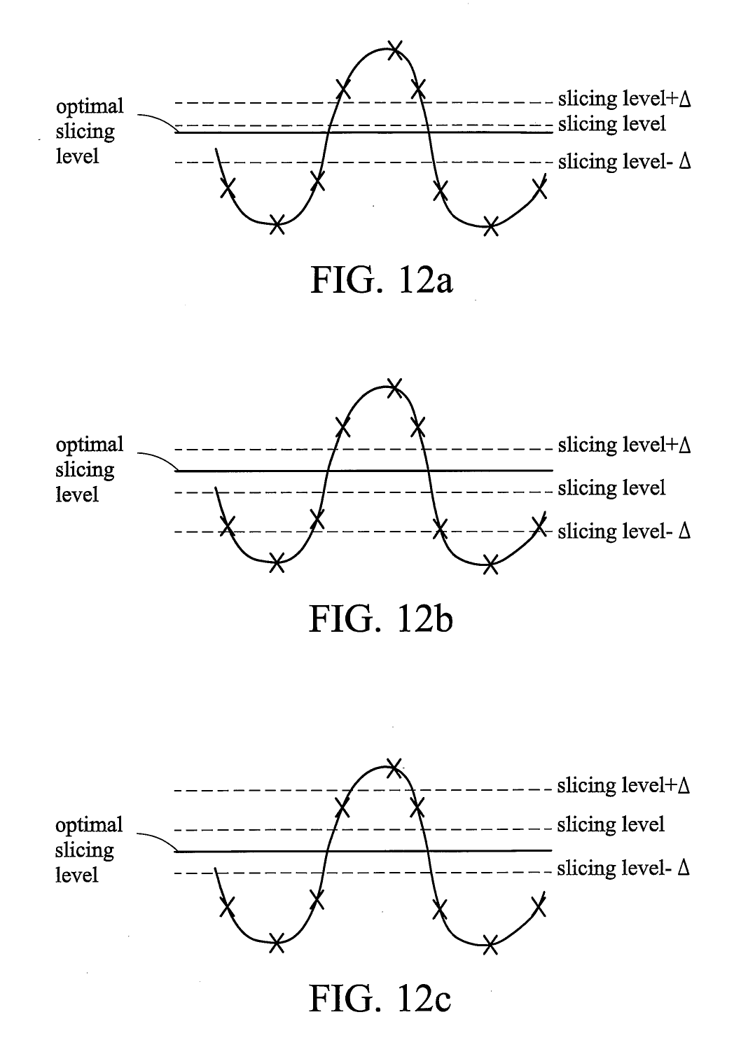

FIG. 12a shows an exemplary diagram of slicing the samples by the slicing level, slicing level+Δ and slicing level−Δ. In the example, the signs of the first sliced data, second sliced data and third sliced data are the same, i.e. {−, −, −, +, +, +, −, −, −}. Since the signs of the first sliced data, second sliced data and third sliced data are the same, the slicing level control 908 or the offset controls 1010 and 1116 does not update the slicing level. FIG. 12b shows another diagram of slicing the samples by the slicing level, slicing level+Δ and slicing level−Δ. The signs of the first sliced data and second sliced data are the same, i.e. {−, −, −, +, +, +, −, −, −}, but the signs of the third sliced data are {+, −, +, ++, +, +, −, +}. The inconsistent signs of the sliced data indicate that the slicing level is too high and requires updating by slicing level control 908 or the offset controls 1010 and 1116. FIG. 12c shows yet another diagram of slicing the samples by the slicing level, slicing level+Δ and slicing level−Δ. The signs of the second sliced data and third sliced data are the same, i.e. {−, −, −, +, +, +, −, −, −}, but the signs of the first sliced data are {−, −, −, −, +, −, −, −, −}. In this condition, the slicing level is too low and requires updating by slicing level control 908 or the offset controls 1010 and 1116.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A channel bit detection system, comprising:
an RF front end receiving an RF signal;
an analog-to-digital converter (ADC) converting the RF signal into a plurality of samples at a sampling rate R;
a combiner producing combined samples by shifting the plurality of samples by an offset value;
an interpolation filter producing a plurality of interpolated samples by interpolating the combined samples, wherein the interpolated samples has a interpolated sampling rate W, and the interpolated sampling rate exceeds the sampling rate R;
a sign detector detecting signs of the plurality of interpolated samples;
an accumulator for accumulating the signs for a predetermined time interval to produce an accumulated value;
an offset control providing the offset value according to the accumulated value; and
a bit detector recovering channel bits from the plurality of combined samples.

2. The channel bit detection system as claimed in claim 1, wherein the accumulator comprises a counter, wherein the counter incrementally increases by one when receiving a positive interpolated sample, and incrementally decreases by one when receiving a negative interpolated sample.

3. The channel bit detection system as claimed in claim 1 further comprising a phase locked loop (PLL) coupled to the combiner recovering a clock signal from the combined samples.

4. The channel bit detection system as claimed in claim 3, wherein the clock signal has a clock rate R, and the analog-to-digital converter converts the RF signal into a plurality of samples according to the clock signal.

5. A channel bit detection system, comprising:
an RF front end receiving an RF signal;
a digital-to-analog (DAC) converter receiving an offset value, and converting the offset value into the analog signal;
a combiner unit combining the RF signal and the analog signal to form a combined signal;
a one-bit analog-to-digital converter converting the combined signal into a plurality of first samples at a sampling rate W; and
a DSV calculator receiving the plurality of first samples to calculate a digital sum value (DSV) of the first samples. an offset control updating the offset value according to the digital sum value;
an analog-to-digital converter (ADC) converting the combined signal into a plurality of samples at a sampling rate R, wherein the sampling rate R is less than the sampling rate W; and
a channel bit detector recovering the channel bit from the plurality of samples.

6. The channel bit detection system as claimed in claim 5 further comprising a phase locked loop (PLL) coupled to the analog-to-digital converter recovering a clock signal from the combined samples.

7. The channel bit detection system as claimed in claim 6, wherein the clock signal has a clock rate R, and the analog-to-digital converter converts the combined signal into the plurality of samples according to the clock signal.

8. A channel bit detection system, comprising:
an RF front end receiving an RF signal;
an analog-to-digital converter converting the RF signal into a plurality of samples at a sampling rate R;
a combiner producing combined samples by shifting the plurality of samples by an offset value;
a length estimator estimating a length of each two consecutive combined samples;
a length accumulator analyzing land lengths and pit lengths of the combined samples according to each length of each two consecutive combined samples;
an offset control providing the offset value according to the land lengths and the pits lengths; and
a channel bit detector recovering channel bits from the plurality of combined samples.

9. The channel bit detection system as claimed in claim 8, wherein the accumulator comprises a counter, wherein the counter incrementally increases by one when receiving a positive interpolated sample, and incrementally decreases by one when receiving a negative interpolated sample.

10. The channel bit detection system as claimed in claim 8 further comprising a phase locked loop (PLL) coupled to the combiner recovering a clock signal from the combined samples.

11. The channel bit detection system as claimed in claim 10, wherein the clock signal has a clock rate R, and the analog-to-digital converter converts the RF signal into a plurality of samples according to the clock signal.

12. The channel bit detection system as claimed in claim 8, wherein the offset control is a first offset control, and the channel bit detector further comprises:
a second combiner producing second combined data according to the plurality of samples and a second offset value;
a DSV calculator calculating a digital sum value of the channel bits; and
a second offset control updating the second offset on the plurality of samples according to the digital sum value;
wherein the channel bit detector recovers the channel bits from the second combined data rather than the plurality of combined samples.

13. The channel bit detection system as claimed in claim 8, wherein the offset control is a first offset control, and the channel bit detector further comprises:
a second combiner producing second combined data according to the plurality of samples and a second offset value;
a DSV calculator calculating a digital sum value of the channel bits; and
a second offset control updating the second offset on the plurality of samples according to the digital sum value;
wherein the phase locked loop recovers the clock signal from the second combined data rather than from the plurality of combined samples.

14. The channel bit detection system as claimed in claim 12, wherein the second combiner produces the second combined samples according to the plurality of samples, the first offset value, and the second offset value.

15. A channel bit detection system, comprising:
an RF front end receiving an RF signal;
an analog-to-digital converter (ADC) converting the RF signal into a plurality of samples at a sampling rate R;
a first combiner combining the plurality of samples with a first offset control;
a equalizer equalizing the first combined samples to produce equalized samples;
a length estimator estimating a length of each two consecutive first equalized samples;
a length accumulator analyzing land lengths and pit lengths of the equalized samples according to each length of each two consecutive equalized samples;
a first offset control providing the first offset for the plurality of samples according to the land lengths and pit lengths;
a phase locked loop (PLL) coupled to the equalizer, recovering a clock signal from the equalized samples;
a second combiner producing a second combined data by combining the equalized samples with a second offset control;
a bit detector recovering the channel bit from the second combined data;
a DSV calculator calculating a digital sum value of the channel bit;
a second offset control updating the second offset on the plurality of samples according to the DSV results.

16. The channel bit detection system as claimed in claim 15 further comprising a sign detector, detecting signs of the second combined samples, and the DSV calculator calculating the digital sum value of the signs.

17. A channel bit detection system, comprising:
an RF front end receiving an RF signal;
an analog-to-digital converter (ADC) converting the RF signal into a plurality of samples at a sampling rate R;
a combiner receiving the plurality of samples, a slicing level value and a delta value to produce a first sliced data, a second sliced data and a third sliced data, wherein the first sliced data is produced by subtracting the slicing level value and the delta value from each of the plurality of samples, the second sliced data is produced by subtracting the slicing level value from each of the plurality of samples, and the third sliced data is produced by adding the delta value with each of the plurality of samples and then subtracting the slicing level value; and
a slicing level control collecting the first, second and third sliced data, detecting signs of the first, second and third sliced data, accumulating the signs for a predetermined time interval to produce a first, second and third accumulated values, and updating the slicing level value according to the first, second and third accumulated values.

18. The channel bit detection system as claimed in claim 17, wherein the slicing level control further comprises:
a first sign detector detecting the signs of the first sliced data;
a second sign detector detecting the signs of the second sliced data;
a third sign detector detecting the signs of the third sliced data;
an accumulator collecting the first, second and third sliced data for adding the three signs and accumulating the signs for a predetermined time interval to produce an accumulated value; and
an offset control updating the slicing level value according to the accumulated value.

19. The channel bit detection system as claim in claim 17, wherein the slicing level control further comprises:
a first sign detector detecting the signs of the first sliced data;
a second sign detector detecting the signs of the second sliced data;
a third sign detector detecting the signs of the third sliced data;
a first accumulator accumulating the signs of the first sliced data for a predetermined time interval to produce a first accumulated value;
a second accumulator accumulating the signs of the second sliced data for the duration of the predetermined time interval to produce a second accumulated value;
a third accumulator accumulating the signs of the third sliced data for the duration of the predetermined time interval to produce a third accumulated value;
a comparator comparing the first, second and third accumulated values, and selecting a minimum accumulated value; and
an offset control updating the slicing level value according to the minimum accumulated value.
